(19) United States
(12) Patent Application Publication
(10) Pub. No.: US 2015/0164121 A1
(43) Pub. Date: Jun. 18, 2015

(54) Food Supplement Composition

(71) Applicant: Homeland Housewares, LLC, Los Angeles, CA (US)

(72) Inventors: Lenny Sands, Los Angeles, CA (US); Elynn DeMattia, Los Angeles, CA (US); Krista Haynes, Manhattan Beach, CA (US)

(73) Assignee: HOMELAND HOUSEWARES, LLC, Los Angeles, CA (US)

(21) Appl. No.: 14/569,483

(22) Filed: Dec. 12, 2014

Related U.S. Application Data
(60) Provisional application No. 61/915,457, filed on Dec. 12, 2013.

(51) Int. Cl. A23L 1/29

(52) U.S. Cl. CPC A23L 1/296; A23V 2002/00

(57) ABSTRACT

A dietary supplement for promoting increased vitality, supporting mood, improving heart health, improving immune strength, improving antioxidant balance, protecting against free radical damage, improving bowel function, and enhancing flavonoid intake. The dietary supplement is a combination of cacao, chia seeds, Goji berries, and maca root. The supplement may be in the form of a pre-made powder or in the form of whole nibs, seeds, and chunks for an individual to powderize on his or her own. The cacao powder may be made from pressed cacao beans, the maca powder derived from maca root grown in high altitudes, and Goji berries derived from spray-dried berries that have a higher vitamin C content compared to Goji berries that are not spray-dried.

### CROSS REFERENCE TO RELATED APPLICATIONS

This application claims benefit of U.S. Provisional Application No. 61/915,457, filed Dec. 12, 2013, the contents of which are hereby incorporated by reference in its entirety.

### FIELD OF THE INVENTION

The invention relates to a food mixture or a category of food mixtures commonly known as superfoods. In particular, the invention relates to organic, natural foods used to supplement the diet for use in vegetable and fruit-based beverages.

### BACKGROUND OF THE INVENTION

The term “superfood” is used in the dietary supplement industry to describe foods that impart health benefits, alleviate medical conditions, and are beneficial for general health and well-being. People are often looking for simple ways to introduce superfoods into their diet. In addition, many individuals would like foods that are tasty, organic, and gluten-free that can be consumed alone or added to food and drink.

Dietary supplement compositions have been used to treat various ailments and produce general improved health. In U.S. Pat. No. 5,925,377, Gerth describes a supplement using a combination of amino acids, minerals, vitamins, and herbs to synergistically act as an appetite suppressant and convert stored fat into energy. In U.S. Pat. No. 7,923,044, Bias describes a dietary supplement that uses powdered grass, algae, freeze-dried vegetables, oat bran, cinnamon and other naturally occurring substances, for reducing cellular damage and preventing premature aging caused by free-radicals. In U.S. Pat. No. 8,257,694, Daikeler describes a nutritional composition for reducing oxidative damage by a composition that includes superfoods such as maca root, Goji berries, mushrooms, basil, and other naturally occurring substances. However, there still remains a need for natural supplements that improve health and well-being. The contents of all references throughout this application are incorporated by reference in their entireties, for all purposes.

### SUMMARY OF THE INVENTION

The nutritional compositions described herein have been shown to have one or more of the following benefits: increase vitality, increase energy, support mood, improve heart health, support immune strength, maintain antioxidant balance, maintain pH balance, support normal bowl function, maintain healthy circulation, protect against free radical damage, improve plasma glucose levels, enhance flavonoid intake, and support healthy joint function.

A general objective of the present invention is to provide highly nutritious, organic groups of foods that can easily be added to food or drinks. In particular, a purpose of the embodiments of the invention is to provide an organic, gluten-free food that can be consumed alone or added to food and drink to provide antioxidants, flavonoids, and phytochemicals, to increase the energy and vitality of an individual in an easy to use delivery system.

Another objective of the present invention is to provide a dietary supplemental composition, which can be readily mixed with or dissolved in other foods (sprinkled on yogurt, mixed with other beverages, added to cereals, etc.). A further objective of the present invention is to provide a 100% vegetarian composition, with no ingredients that are commonly associated with allergens, without added sweeteners, and without any artificial flavors, excipients or fillers.

The embodiments of the invention are a blend of organic superfoods in in a whole food form or ground powder form. Some embodiments can easily be added to existing foods or beverages. Some constituents of the compositions in the embodiments are made using unique processes of cleaning and drying that retain the nutrient profile of the raw unprocessed constituents.

In accordance with a preferred embodiment, the nutritional composition comprises the constituents of: cacao (Theobroma cacao), chia seed (Salvia hispanica), Goji berry (Lycium barbarum), and maca root (Lepidium meyenii). In a particular embodiment, the constituents are in powder form. In another embodiment, the cacao is in the form of Cacao nibs, the maca root is in the form of toasted maca chunks, and the Goji berries are in the form of dried Goji berries.

In accordance with yet another embodiment, a method of beneficially affecting any of the health benefits described above is produced by orally administering any one or more of the compositions to produce the desired health benefit.

Preferably, all constituents in the above formulations are organic. In any of embodiments, the composition may be comprised of, consist of, or consist essentially of some or all of the listed constituents. Other objects, features, and advantages of the present invention will become apparent to those skilled in the art from the following detailed description.

### DETAILED DESCRIPTION OF THE EMBODIMENTS

A more complete appreciation of the disclosure and many of the associated advantages will be readily obtained, as the same becomes better understood by reference to the following detailed description of the exemplary embodiments.

In a preferred embodiment that increases vitality, supports, mood, and supports heart health, the nutritional composition comprises at least one, but preferably all, of the constituents in Table 1. The amounts provided preferably have a serving size of 5.7 grams. A single serving has approximately 25 calories total, 5 calories from fat, 3 grams of carbohydrate (of which 2 grams are dietary fiber and less than one gram is sugar), and 1 gram of protein.

TABLE 1

| Constituent | Preferred Percent Range | Preferred Percent |
|---|---|---|
| Organic Cacao Powder | 30.0%-70.0% | 50.0% |
| Organic Chia Seed Powder | 10.0%-30.0% | 30.0% |
| Organic Goji Berry Powder | 5.0%-25.0% | 15.0% |
| Organic Maca Root Powder | 5.0%-25.0% | 5.0% |

In a preferred whole-food embodiment that increases vitality, supports, mood, and supports heart health, the nutritional composition comprises at least one, but preferably all, of the constituents in Table 2. The amounts provided preferably have a serving size of approximately 5.7 grams. A single serving has approximately 30 calories total, 15 calories from fat (of which there are 1.5 grams of total fat and 0.5 grams of saturated fat), 5 mg of sodium, 3 grams of total carbohydrate (of which there are 2 grams of dietary fiber and less than 1 gram of sugar), and 1 gram of protein.

TABLE 2

| Constituent | Preferred Percent Range | Preferred Percent |
|---|---|---|
| Organic Cacao Nibs | 30.0%-70.0% | 50.0% |
| Organic Chia Seeds | 10.0%-30.0% | 20.0% |
| Organic Toasted Maca | 5.0%-25.0% | 15.0% |
| Chunks | | |
| Organic Dried Goji Berries | 5.0%-25.0% | 15.0% |

In the embodiments of the compositions in Table 1 and Table 2, a range of 6-12 grams of the composition provides 200%-400% of vitamin C. The percent of each of the constituents is given as percent weight. These embodiments are low in calories, but high in flavonoid content, and regulate blood-sugar levels. The embodiments increase a feeling of satiety when added to other foods, such as smoothies, due to the combined fiber content and viscosity of the drink.

Cacao has been known to support heart health, is rich in antioxidants, and supports bone strength. The cacao in the described compositions may be processed by traditionally used processing means, but the compositions have added benefits if the cacao is carefully sourced and processed. Organic, gentle cleaned cacao nibs retain phenolic compounds and flavonoids with antioxidant and mood enhancing properties. Roasting cacao beans, which is commonly practiced in the industry, reduces the amount of antioxidants and other nutrients in the cacao. To ensure that phenolic compounds are not compromised, the cacao beans are derived from freshly-split pods from good exporting countries, such as Peru, and are fermented under control temperatures (40° C.), washed and solar dried. The dried cacao beans are then cracked into nibs and the outer skin gently blown off with fans. The cacao nibs are placed into a hydraulic press that pressed out the oil of the cacao bean, which leaves behind a concentrated cacao cake that is low in fat (approximately 11% to 13% by weight, fat). The cacao nibs may be used in this state, or further cold milled into a powder, then sieved for use as cacao powder. This composition contains approximately 50% to 70% cacao. The cacao composition provides a significant amount of antioxidants and also imparts a familiar, satisfying flavor to users who add it to their food, drink or smoothie.

Maca is known to increase energy, improve performance, and increase vitality. In a preferred embodiment, the Maca root in the described compositions is selected from the Lepidium meyenii species that is grown in an altitude of approximately 9,000 to 14,000 feet (approximately 2700 to 4300 meters) above sea level.

Goji berries are known to increase vitality, have a high vegan source of protein, and are rich in antioxidants. In a preferred embodiment, the Goji berries are spray-dried to retain antioxidant vitamin C. Typically, Goji berries on the market do not contain vitamin C as most of the vitamin C is lost during drying processes.

Chia seeds are known to help maintain normal blood sugar levels, promote normal bowel function, and produce high alpha-linoleic and eicosapentaenoic acid levels, while not contributing to inflammation or disease risk factors.

The above description is for ease of reference only, and is not intended to be a definitive description of the subject matter.

I claim:

1. A dietary supplement composition comprising:
about 30% to about 70% by weight cacao powder;
about 10% to about 30% by weight chia seed powder;
about 5% to about 25% by weight Goji berry powder; and
about 5% to about 25% by weight Maca root powder.

2. The composition of claim 1 comprising:
about 50% by weight cacao powder;
about 30% by weight chia seed powder;
about 15% by weight Goji berry powder; and,
about 5% by weight Maca root powder.

3. The composition of claim 1,
wherein the cacao powder is derived from cacao beans pressed into a concentrated cacao cake having approximately 11% to 13% by weight fat content;
wherein the maca powder is derived from maca root grown in an altitude of about 9,000 to 14,000 feet (about 2,700 to 4,300 meters) above sea level; and,
wherein the Goji berry powder is derived from spray dried Goji berries, whereby the spray dried Goji berries have a higher vitamin C content compared to non-spray dried Goji berries.

4. A composition comprising:
about 30% to about 70% by weight cacao nibs;
about 10% to about 30% by weight chia seeds;
about 5% to about 25% by weight dried Goji berries; and,
about 5% to about 25% by weight toasted Maca chunks.

5. A composition of claim 4 comprising:
about 50% by weight cacao nibs;
about 20% by weight chia seeds;
about 15% by weight dried Goji berries; and
about 15% by weight toasted Maca chunks.

6. The composition of claim 4,
wherein the cacao powder is derived from cacao beans pressed into a concentrated cacao cake having approximately 11% to 13% by weight fat content;
wherein the maca powder is derived from a maca root grown in an altitude of about 9,000 to 14,000 feet (about 2700 to 4300 meters) above sea level; and,
wherein the Goji berries are derived from Goji berries that have been spray dried, whereby spray dried Goji berries have a higher vitamin C content than non-spray dried Goji berries.
